(19) United States
(12) Patent Application Publication
(10) Pub. No.: US 2022/0091772 A1
(43) Pub. Date: Mar. 24, 2022

(54) MEMORY SYSTEM

(71) Applicant: KIOXIA CORPORATION, Tokyo (JP)

(72) Inventors: Toshio FUJISAWA, Yokohama Kanagawa (JP); Tomoya SANUKI, Yokkaichi Mie (JP); Hitomi TANAKA, Ota Tokyo (JP); Takeshi ISHIHARA, Yokohama Kanagawa (JP); Yasuhito YOSHIMIZU, Yokkaichi Mie (JP)

(21) Appl. No.: 17/410,674

(22) Filed: Aug. 24, 2021

(30) Foreign Application Priority Data
Sep. 18, 2020 (JP) 2020-157357

(51) Int. Cl. G06F 3/06

(52) U.S. Cl. CPC G06F 3/0652; G06F 3/064; G06F 3/0679; G06F 3/0604; G06F 3/0631

(57) ABSTRACT

According to one embodiment, a memory system includes a non-volatile semiconductor memory with a plurality of blocks. A controller in the system controls the writing of data to the non-volatile semiconductor memory and includes a host I/F control interface to receive write command information including file allocation information indicating a location for write data, a file information management unit to assign an erasure level to a file and output a file identifier in which a file name, a file size, and the erasure level of the file are combined, and a flash translation layer unit to allocate each file on a single file per block basis based on the write command information and the file identifier.

### CROSS-REFERENCE TO RELATED APPLICATION

This application is based upon and claims the benefit of priority from Japanese Patent Application No. 2020-157357, filed Sep. 18, 2020, the entire contents of which are incorporated herein by reference.

### FIELD

Embodiments described herein relate generally to a memory system.

### BACKGROUND

A memory system including a non-volatile semiconductor memory erases data in units of a block (for example, 1 MB), which is the minimum unit size in which the non-volatile semiconductor memory can be erased. The block is larger than a page (which is, for example, just 4 KB in size), which is the minimum unit size in which data can be written and read.

The memory system converts logical addresses used by a host to physical addresses in the memory system, thus, in some instances, when a host directs deleting of data (by logical address), the corresponding data in the physical block is set as invalid and such invalidated data may still remain until the data in the physical block is erase. Thus, even if the host device considered this invalidated data to have been erased, the data may still remain in the physical block of the non-volatile semiconductor memory and can possibly still be read by analytic methods.

### BRIEF DESCRIPTION OF THE DRAWINGS

FIG. 1 is a block diagram illustrating a configuration of a memory system according to an embodiment.

FIG. 2 is a diagram illustrating a configuration of a file system.

FIG. 3 is a diagram illustrating a configuration of directory entries.

FIG. 4 is a diagram illustrating a file allocation table (FAT) structure.

FIG. 5 is a flowchart illustrating an operation flow of a file information management unit according to an embodiment.

FIG. 6 is a flowchart illustrating an operation flow of a flash translation layer unit according to an embodiment.

FIG. 7 is a diagram illustrating an operation mode A for writing to a NAND block according to an embodiment.

FIG. 8 is a field table of directory entries for using the elapsed time since the last update date to a file according to an embodiment.

FIG. 9 is a block diagram illustrating a configuration of a memory system according to an embodiment.

FIG. 10 is a diagram illustrating an operation when a memory system according to an embodiment receives a UNMAP command.

FIG. 11 is a flowchart illustrating an operation flow of a flash translation layer unit according to an embodiment.

FIG. 12 is a block diagram illustrating a configuration of a memory system according to an embodiment.

FIG. 13 is a flowchart illustrating an operation flow of a host I/F control unit according to an embodiment.

FIG. 14 is a block diagram illustrating a configuration of a memory system according to an embodiment.

FIG. 15 is a flowchart illustrating an operation flow of a comparator according to an embodiment.

FIG. 16A is a diagram illustrating an example of operation mode B for writing to a NAND block according to an embodiment.

FIG. 16B is a diagram illustrating an example of copying a file of a NAND block to another NAND block.

FIG. 16C is a diagram illustrating an example of erasing a NAND block after the copying of a file from the NAND block.

### DETAILED DESCRIPTION

Embodiments provide a memory system with an improved security level.

In general, according to one embodiment, a memory system includes a non-volatile semiconductor memory having a plurality of blocks. A controller in the system is configured to control the writing of data to the non-volatile semiconductor memory. The controller has a host I/F control interface configured to receive write command information including file allocation information indicating a location for write data, a file information management unit configured to assign an erasure level to a file corresponding to the file allocation information and output a file identifier in which a file name, a file size, and the erasure level of the file are combined, and a flash translation layer unit configured to allocate one file per block based on the write command information and the file identifier.

Hereinafter, certain example embodiments will be described with reference to the drawings. In the description of the drawings, the same or substantially similar parts are designated by the same reference numerals. The drawings are schematic and presented for the purpose of describing certain aspects of the present disclosure. The specific embodiments exemplify devices and methods embodying certain technical concepts of the present disclosure, but the present disclosure is not limited to the specific examples. Various modifications and alterations may be made to the described embodiments.

### First Embodiment

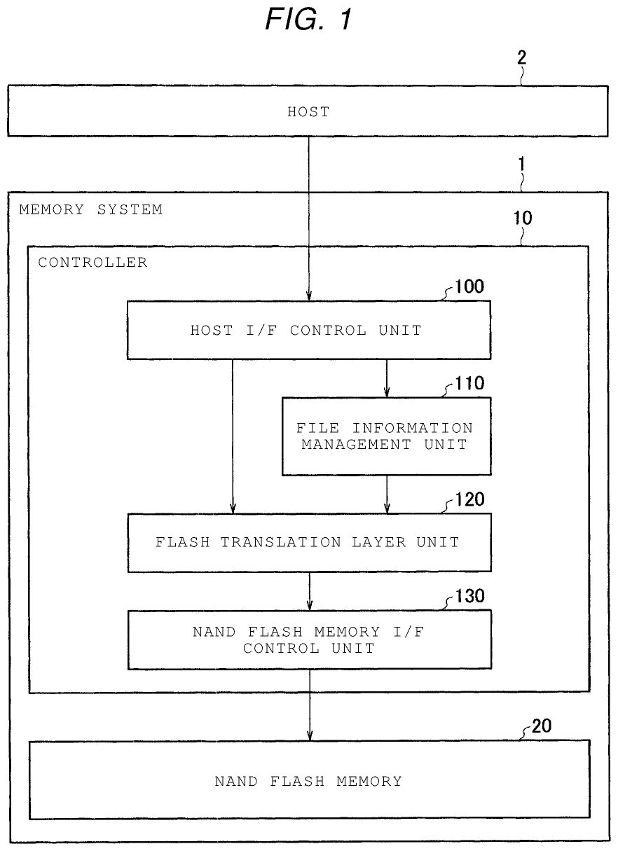

FIG. 1 is a block diagram illustrating a configuration of a memory system 1 according to the first embodiment. As shown in FIG. 1, the memory system 1 includes a controller 10 and a non-volatile semiconductor memory 20. In the following description, aspects only concerning the reading of data from non-volatile semiconductor memory 20 are omitted for simplicity, but memory system 1 is capable of both reading and writing data to non-volatile semiconductor memory 20.

The memory system 1 is connected to a host device 2 (host 2). The memory system 1 functions as an external storage device of the host 2. In general, any standard protocol may be employed as the communication standard for connecting the memory system 1 and the host 2.

The host 2 is a computer including a built-in file system driver. The computer may be, for example, a personal computer, a server, a portable information device, and an AV device. The host 2 sends data to and received data from the memory system 1 via the file system driver.

Aspects of a file system for managing data on the memory system 1 will be described with reference to FIGS. 2, 3, and 4.

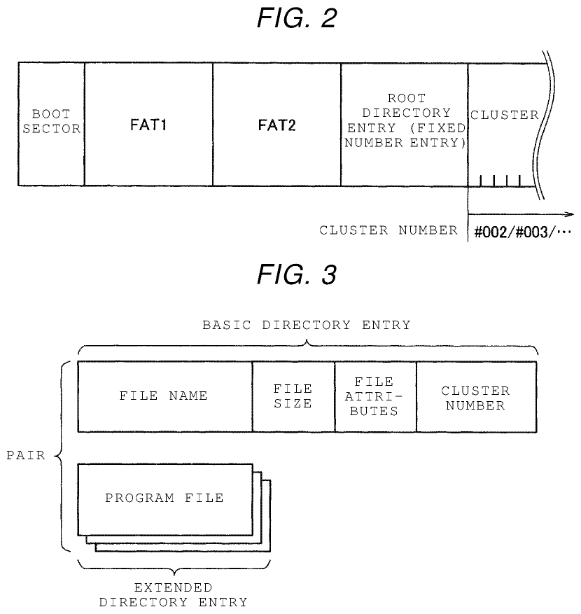

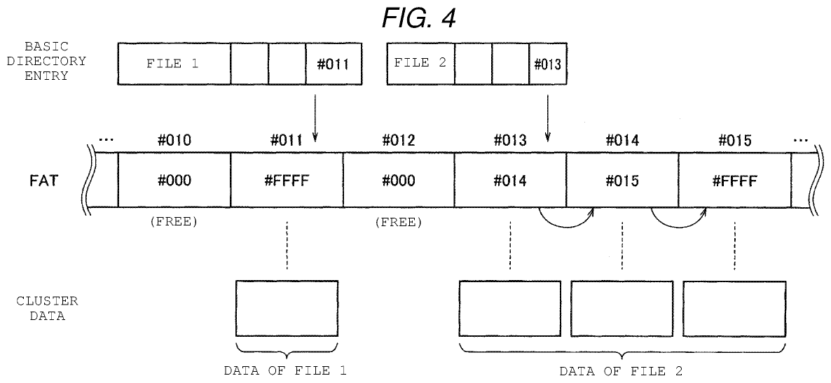

FIG. 2 is a diagram illustrating a configuration of a file system. FIG. 3 is a diagram illustrating a configuration of directory entries. FIG. 4 is a diagram illustrating a FAT structure.

As shown in FIG. 2, in the format of the FAT file system, the boot sector, FAT (File Allocation Table) 1, FAT2, root directory entry (fixed number entry), and cluster number are arranged in this order.

A set of instructions to boot is recorded in a boot sector. The same data is recorded in FAT1 and FAT2 as a failure countermeasure. A root directory entry records directory entries that store the information about the file to be saved in the file system. As for the cluster number, the data for a starting cluster number for the data is recorded. In FAT1 and FAT2, there are two identical sets of data because the FAT system manages the allocation of files and data, and if any FAT data is damaged, the system is greatly affected, so FAT data is multiplexed (stored in two different locations) to reduce the risk of loss.

As shown in FIG. 3, the format of the directory entry recorded in the root directory entry includes a pair with a basic directory entry and an extended directory entry. The basic directory entry may include, for example, a file name, a file size, file attributes, and a cluster number. In addition, as other information, an update date and a creation date may be included in the basic data entry. The extended directory entry may include program files, which are cluster data of files.

In the example depicted in FIG. 4, “file 2” is referenced to the starting or first cluster location where the actual data corresponding to the file is recorded in the FAT. For file 2, the first cluster number #013 is recorded in the basic directory entry. The entry information listed in FAT #013 is #014, which further refers to FAT #014. The entry information listed in FAT #014 is #015, which further refers to FAT #015.

The entry information recorded in FAT #015 is #FFFF in this example and, in this context, #FFFF means the end of the file. Therefore, it can be seen that the file 2 is a file corresponding to the clusters from #013 to #015.

When a file from the host 2 is written to the memory system 1, the file information of FAT1, FAT2, and the root directory entry of the file system is updated. Furthermore, the file system information is also stored in the NAND flash memory 20 and the file system information stored in the NAND flash memory 20 is also updated at some predetermined timing.

Next, the configuration of the memory system 1 according to the first embodiment will be described with reference to FIG. 1.

The controller 10 communicates with the host 2 and controls the operation of the entire memory system 1. The controller 10 may be, for example, a semiconductor integrated circuit such as a System on Chip (SoC).

The NAND flash memory 20 is connected to the controller 10 and stores data under the control of the controller 10. The NAND flash memory 20 will be described as an example of a non-volatile semiconductor memory in this embodiment, but the present disclosure is not limited to use of NAND flash memory as non-volatile memory. Other types of non-volatile semiconductor memory such as three-dimensional (3D) flash memory, NOR flash memory, or magnetoresistive random access memory (MRAM) may be utilized in place or in addition to NAND flash memory 20.

The controller 10 includes a host I/F control unit 100, a file information management unit 110, a flash translation layer unit 120, and a NAND flash memory I/F control unit 130.

The host I/F control unit 100 is an interface device for communicating with the host 2. The host I/F control unit 100 receives, for example, the write command information issued by the host 2.

The write command information may include write commands and write data. The write command may include a command type indicator indicating that it is a write command, file allocation information indicating the location for write data, a write data size, and a stream ID (stream identifier).

The file allocation information is expressed in the format of a logical block address (LBA), for example. In the following description, the file allocation information is a logical address indicating the location for the write data and may also be referred to as LBA information. The file allocation information used by the host 2 to specify the location for the write data in the memory system 1 may be expressed as a logical address.

In this context, a “stream” is a set of data that is expected to be invalidated collectively whenever the host 2 invalidates data. That is, the stream ID is an identifier that can be set according to the expected lifetime of data.

The lifetime of data is the length of time from when the data is first written to the memory system 1 until the data will be rewritten. The rewriting may include issuing write command information multiple times by designating the duplicate logical address of the host 2.

The rewriting may also include a process of invalidating the previously established relationship between the logical address and the physical address. The process of invalidating the correspondence between the logical address and the physical address is executed, for example, in response to a TRIM command or a UNMAP command.

The host I/F control unit 100 outputs the write command information received from the host 2 to the file information management unit 110 and the flash translation layer unit 120.

The file information management unit 110 manages the erasure level of the file that is to be written. The file information management unit 110 extracts the file allocation information from the write command information including the LBA received from the host I/F control unit 100. An erasure level can be assigned based on this file allocation information (e.g., by address range or the like). In addition, a file identifier in which the file name, file size, and erasure level are combined is stored in an internal memory accessible by the file information management unit 110. The erasure level can reflect the difficulty of restoring data.

That is, the file information management unit 110 assigns an erasure level to the LBA on the memory system 1 for the LBA on the file system managed by the host 2 and reconstructs the file system.

The internal memory accessible by the file information management unit 110 may be, for example, a general-purpose memory such as SRAM or DRAM. This internal memory may be mounted in the controller 10 or outside the controller 10.

The flash translation layer unit 120 manages the LBA and the physical addresses of the NAND flash memory 20 on a one-to-one basis. Specifically, the flash translation layer unit 120 translates and manages the logical address (which is a LBA) included in the write command information received from the host 2, and the physical address (which is the location information) in the NAND flash memory 20. In the following description, the physical address of the NAND block in the NAND flash memory 20 may be referred to as a physical block address (PBA).

In addition to the mapping management function of the logical-to-physical address translation table, the flash translation layer unit 120 may include a function of executing garbage collection (“GC,” which is also referred to as “compaction”) for the NAND flash memory and flash management functions such as block management, wear leveling, and randomization as may be possessed by a flash translation layer (FTL) of the related art.

The NAND flash memory I/F control unit 130 is an interface device for communicating with the NAND flash memory 20. The NAND flash memory I/F control unit 130 receives, for example, an execution command for the PBA, data size, and erasure level issued by the flash translation layer unit 120. The NAND flash memory I/F control unit 130 outputs the received information to the NAND flash memory 20.

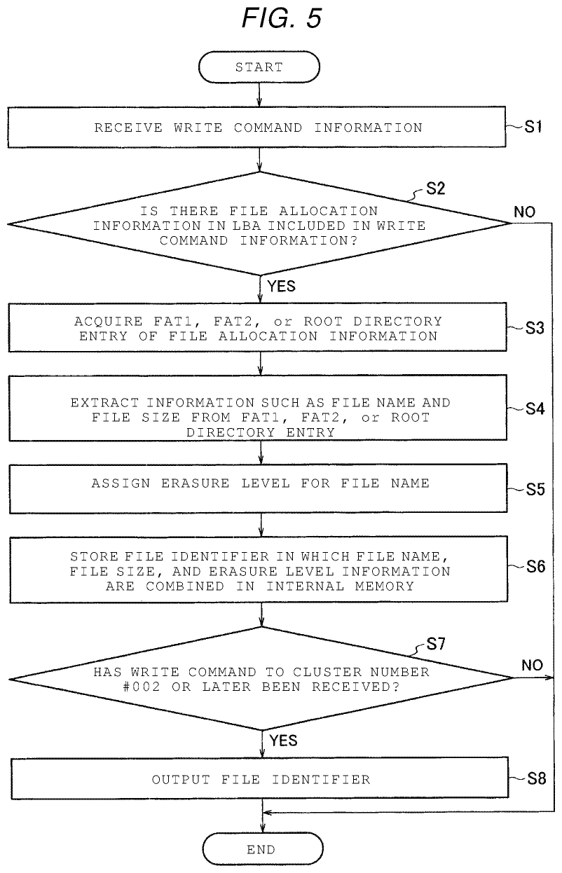

With reference to FIG. 5, the operation flow of the file information management unit 110 when writing data to the memory system 1 according to the first embodiment will be described.

FIG. 5 is a flowchart illustrating an operation flow in the writing of the file information management unit 110 according to the embodiment.

In step S1, the file information management unit 110 receives the write command information from the host I/F control unit 100.

In step S2, the file information management unit 110 determines whether the LBA included in the write command information received from the host I/F control unit 100 includes file allocation information.

The presence of this file allocation information means that the location indicated by the file allocation information includes information within the range of FAT1, FAT2, or root directory entry of the file system.

If the write command information includes file allocation information, the process proceeds to step S3. If there is no file allocation information in the write command information, the process proceeds to the end.

In step S3, the file information management unit 110 acquires the information of FAT1, FAT2, or the root directory entry from the file allocation information.

In step S4, the file information management unit 110 extracts the file name and file size from the information of FAT1, FAT2, or the root directory entry (for example, from the beginning of the data to 32 bytes).

In step S5, the file information management unit 110 assigns an erasure level corresponding to the extracted file name. In this method of assigning an erasure level, for example, the file information management unit 110 assigns a specified value unless otherwise instructed by the host 2. This specified value may be given, for example, 0 indicating that the erasure level is low.

Here, a low erasure level means that, for example, it is easy to restore the corresponding data and even if the data was to be deleted on the file system, the data can be read by analyzing the NAND flash memory 20. A high erasure level means, for example, a state in which it is difficult to restore data and the file erased on the file system will also be deleted from the NAND flash memory 20.

Instep S6, the file information management unit 110 stores, in internal memory, a file identifier in which the extracted file name and file size, and the erasure level information are combined. The file information management unit 110 may update the contents of the erasure level included in the file identifier recorded in the internal memory upon instruction from the host 2.

That is, for example, the file information management unit 110 can cause the value of the erasure level to be updated from 0 to 1 indicating that the erasure level is updated to high according to an instruction from the host 2. If the same file name already exists, the file identifier in the internal memory does not need to be updated.

In step S7, if the received write command information includes a write command to the cluster number 002 or later, in which the cluster number 002 is the head of the user data area in the cluster shown in FIG. 2, the process proceeds to step S8. If the received write command information does not include a write command to cluster number 002 or later, the process proceeds to the end. Generally, in the FAT file system, the cluster number 001 and the cluster number 000 before the cluster number 002 do not exist and the head of the cluster is the cluster number 002.

Instep S8, the file information management unit 110 outputs the file identifier to the flash translation layer unit 120.

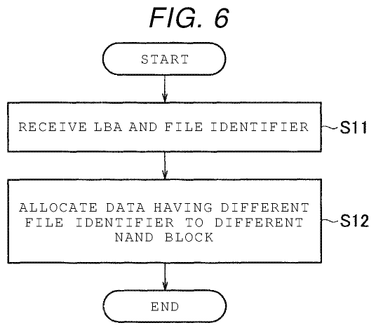

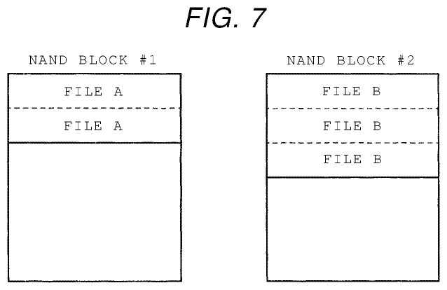

The operation flow of the flash translation layer unit 120 when writing data to the memory system 1 according to the first embodiment will be described with reference to FIGS. 6 and 7.

FIG. 6 is a flowchart illustrating an operation flow of the flash translation layer unit 120 according to the first embodiment. FIG. 7 is a diagram illustrating an operation mode A for writing to a NAND block.

In step S11, the flash translation layer unit 120 receives, for example, write command information including an LBA from the host I/F control unit 100. If the LBA included in the write command information includes file allocation information, the file identifier is received from the file information management unit 110.

In step S12, when translating the LBA for the data write destination to a PBA, the flash translation layer unit 120 allocates data having different file identifiers to different NAND blocks. The flash translation layer unit 120 outputs information for the PBA and data size of the LBA included in the write command information to the NAND flash memory I/F control unit 130.

That is, as shown in FIG. 7, the flash translation layer unit 120 allocates the NAND block #1, which is a physical address in the NAND flash memory 20, to the file A having one file identifier. Further, the NAND block #2, which is a physical address in the NAND flash memory 20, is allocated to the file B having another different file identifier. The operation mode in which the flash translation layer unit 120 allocates one file in the NAND block of one or a plurality of NAND flash memories 20 in this way is referred to as an operation mode A.

In the first embodiment, the memory system 1 extracts the filename from the write command information received from the host I/F control unit 100 and reconstructs the file system (e.g., FAT file system) information.

Using the file allocation information included in this reconstructed LBA, the data included the file is written into limited (minimum) number of NAND blocks (operation mode A).

That is, the memory system 1 can change the erasure level for each file by identifying the erasure level for each file.

Furthermore, since the memory system 1 can delete a file having a high erasure level at once (without performing garbage collection) by analyzing the file configuration using the erasure level, the erased data is hard to be restored and the security level of the memory system 1 can be improved.

### Second Embodiment

In the memory system 1 according to the first embodiment, in the step S5 shown in FIG. 5, the file information management unit 110 assigns a specified value or assigns an erasure level by a special or specific instruction from the host 2, as a method of allocating the erasure level.

On the other hand, in the memory system 1 according to the second embodiment, the file information management unit 110 assigns an erasure level according to the elapsed time since the last update date of the file.

Specifically, for the second embodiment, in step S4 shown in FIG. 5, in addition to the file name and the file size information, the last update date for the file is further extracted. Furthermore, in step S5 shown in FIG. 5, the file information management unit 110 calculates the elapsed time since the last update date of the extracted file to the present and assigns an erasure level for the file name using this elapsed time. The target file may be, for example, a file written in a specific partition such as a cache partition for which data can be erased without permission or request.

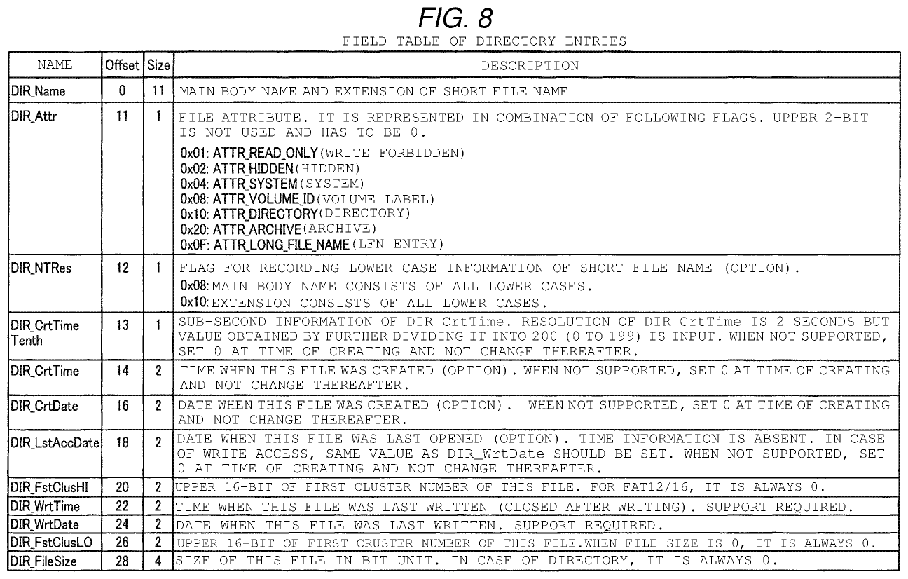

FIG. 8 is a field table of directory entries for using the elapsed time from the last update date of a file to the present.

As shown in FIG. 8, the last update date of the file can be extracted by extracting the data of “DIR_WrtTime” and “DIR_WrtDate” in the field table of the directory entries.

That is, in step S4, the file information management unit 110 extracts the last update date of the file by using “DIR_WrtTime” and “DIR_WrtDate” from the data of the directory entry.

Other configurations, operation flows, and effects of the memory system are the same as those of the first embodiment shown in FIGS. 1 to 7.

### Third Embodiment

In the memory system 1 according to the second embodiment, for step S5 shown in FIG. 5, the file information management unit 110 assigns an erasure level according to the last update date for the file as a method of assigning the erasure level. On the other hand, in the memory system 1 according to the third embodiment, the file information management unit 110 assigns an erasure level by use of machine learning.

Specifically, in step S4 shown in FIG. 5, in addition to the file name and the file size information, the creation date and time for the file as well as the date when the file was last opened are extracted. In step S5 shown in FIG. 5 for this third embodiment, as a machine learning method, the file information management unit 110 calculates the frequency of use of the file based on its creation date and time and the date when the file was last opened, estimates whether the file is a deletable file and assigns an erasure level accordingly.

As shown in FIG. 8, the creation date and time of the file and the date when the file was last opened can be extracted by extracting the data of “DIR_CrtTime”, “DIR_CrtDate”, and “DIR_LstAccDate” in the field table of the directory entries.

That is, in step S4 for the third embodiment, the file information management unit 110 extracts the creation date and time of the file and the date when the file was last opened by using “DIR_CrtTime”, “DIR_CrtDate”, and “DIR_LstAccDate” from the data of the directory entry.

Other configurations, operation flows, and effects of the memory system are the same as in the second embodiment shown in FIG. 8.

### Fourth Embodiment

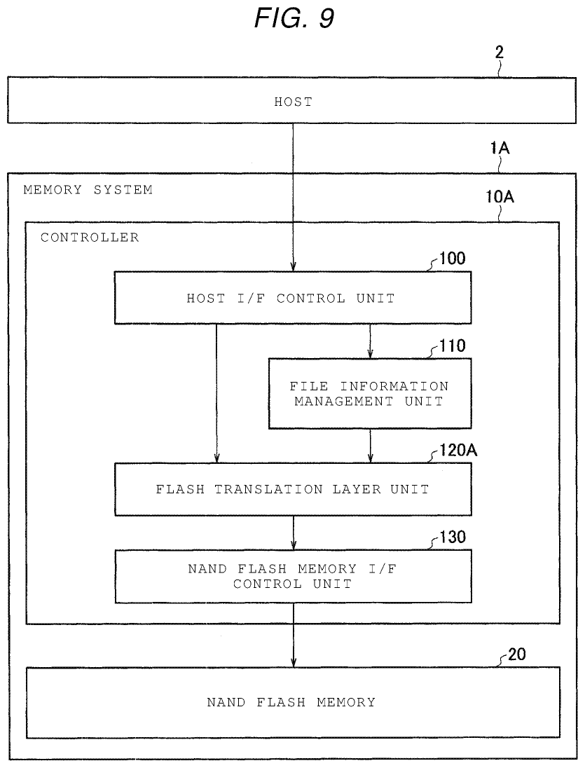

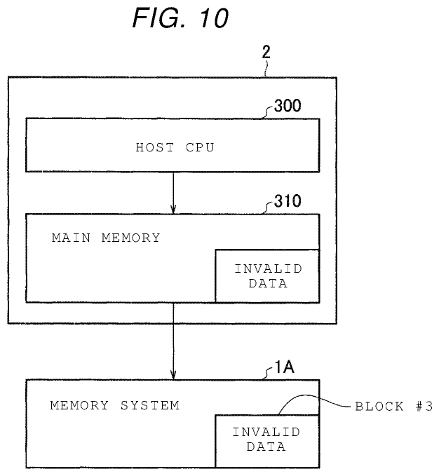

FIG. 9 is a block diagram illustrating the configuration of a memory system 1A according to the fourth embodiment. FIG. 10 is a diagram illustrating the operations on a file in the file system when the memory system 1A receives a UNMAP command.

In the memory system 1 (according to the first embodiment), in step S11 shown in FIG. 6, the flash translation layer unit 120 receives the write command information including the LBA from the host I/F control unit 100.

On the other hand, in the memory system 1A according to the fourth embodiment, a flash translation layer unit 120A (shown in FIG. 9) receives a UNMAP or TRIM command from the host I/F control unit 100 rather than a write command. Furthermore, at the time of a garbage collection (GC), an erasure level is selected by referring to the erasure level included in the file identifier of the file, and a block erase command or a deallocate command (also referred to as a deallocation or deallocation command) is output according to the erasure level.

A garbage collection is a process to move valid data to a free block in another block, and then to generate a block that can be reused for writing (a write destination block) by collecting invalid data stored in the move source block.

That is, when the memory system 1A executes a UNMAP or TRIM command received by the host I/F control unit 100 or garbage collection, the flash translation layer unit 120A refers to the erasure level of the file and outputs a block erase command or a deallocate command to the NAND flash memory I/F control unit 130 according to the selected erasure level. The memory system 1A performs substantially similar to memory system 1A with respect to write command information from the host 2.

The garbage collection may be executed in the background at the same time when the UNMAP command and the TRIM command are received.

For example, the data before updating the file in block #3 on the memory system 1A shown in FIG. 10 is invalidated. At this time, the memory system 1A according to the fourth embodiment refers to the erasure level of the file with respect to the data before the file update, and when the erasure level is high, the invalid data of the file in block #3 is immediately block-erased, which can improve the security level.

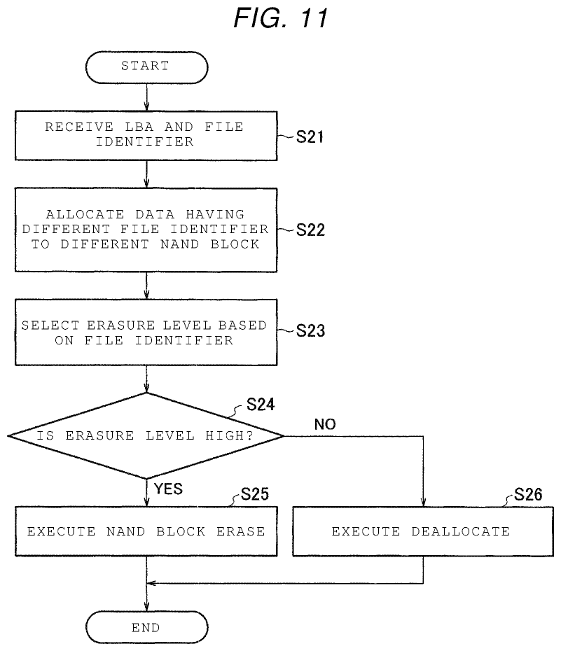

FIG. 11 is a flowchart illustrating an operation flow of the flash translation layer unit 120A according to the fourth embodiment.

In step S21, the flash translation layer unit 120A shown in FIG. 9 receives, for example, a UNMAP or TRIM command from the host I/F control unit 100. Since the LBA is included in the UNMAP or TRIM command, the file identifier is received from the file information management unit 110.

In step S22, the flash translation layer unit 120A translates the LBA specified by the UNMAP or TRIM command into PBA and outputs the information of the PBA and data size to the NAND flash memory I/F control unit 130.

In step S23, the flash translation layer unit 120A selects an erasure level based on the file identifier when invalidating the write source file by optimization.

In step S24, the flash translation layer unit 120A selects a method for erasing the NAND block containing the invalidated write source file based on the erasure level read from the file identifier.

If the erasure level read from the file identifier is high (for example, the erasure level value is 1), the process proceeds to step S25. If the erasure level read from the file identifier is low (for example, the erasure level value is 0), the process proceeds to step S26.

In step S25, the flash translation layer unit 120A outputs, for example, a command to execute NAND block erase on the NAND block containing the invalidated write source file to the NAND flash memory I/F control unit 130 according to the selected erasure level.

In step S26, the flash translation layer unit 120A outputs, for example, a command to execute a deallocate (deallocation) to the NAND flash memory I/F control unit 130 according to the selected erasure level.

As described above, a solid-state drive (SSD), which is one possible example of the memory system 1A, receives a UNMAP or TRIM command. At this time, files with a high erasure level in the invalid data generated by the UNMAP or TRIM command and/or garbage collection can be deleted immediately on the memory system 1A, and thus, the erased files become difficult to be restored and the security level of the memory system 1A can be further improved.

Other configurations, operation flows, and effects of the memory system are the same as those of the first embodiment shown in FIGS. 1 to 7.

### Fifth Embodiment

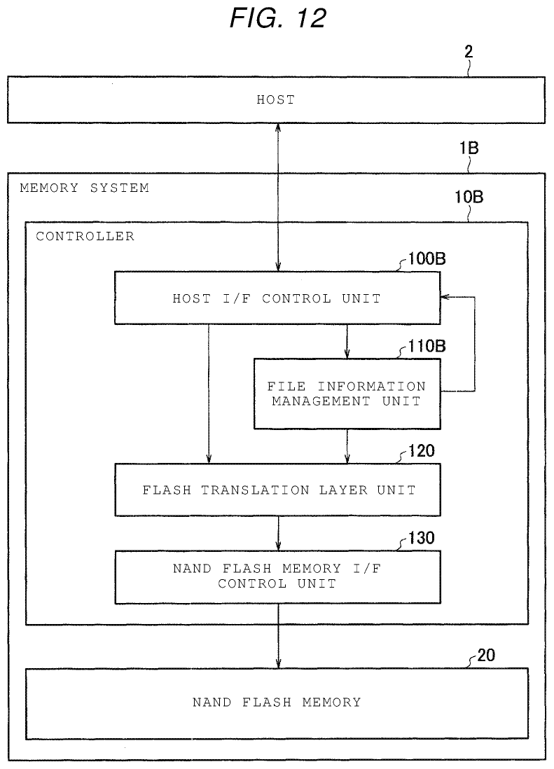

FIG. 12 is a block diagram illustrating the configuration of a memory system 1B according to the fifth embodiment.

In the memory system 1A according to the fourth embodiment, the host I/F control unit 100 shown in FIG. 9 receives a UNMAP or TRIM command from the host 2. Furthermore, the file information management unit 110 shown in FIG. 9 manages the erasure level of each file and block-erases when the erasure level of an invalidated file is high.

On the other hand, in the memory system 1B according to the fifth embodiment, a host I/F control unit 100B shown in FIG. 12 further provides a file deletion command function. The host I/F control unit 100B receives the deletable file information output from the file information management unit 110B and outputs the deletable file information to the host 2.

The file information management unit 110B extracts deletable file candidates and outputs the deletable file information to the host I/F control unit 100B.

As the deletable file information, for example, deletable file candidates may be extracted based on the elapsed time of the file obtained in the second embodiment. In addition, files obtained by machine learning as obtained in the third embodiment may be extracted as deletable file candidates.

That is, in the memory system 1B, the file information management unit 110B extracts deletable file information and outputs deletable file information to the host I/F control unit 100B. The host I/F control unit 100B then outputs the deletable file information to the host 2. The host 2 can output a file deletion request to the host I/F control unit 100B based on the deletable file information from the file information management unit 110B.

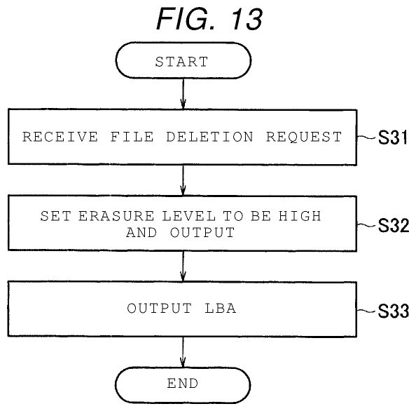

FIG. 13 is a flowchart illustrating an operation flow when the host I/F control unit 100B according to the fifth embodiment receives a file deletion request.

In step S31, the host I/F control unit 100B receives a file deletion request from the host 2.

In step S32, the host I/F control unit 100B raises the erasure level of the file included in the file deletion request issued by the host 2 based on the deletable file information sent by the file information management unit 110B and outputs the erasure level.

In step S33, the host I/F control unit 100B outputs the LBA of the file in the file deletion request.

Other configurations, operation flows, and effects of the memory system are the same as those of the fourth embodiment shown in FIGS. 9 to 11.

### Sixth Embodiment

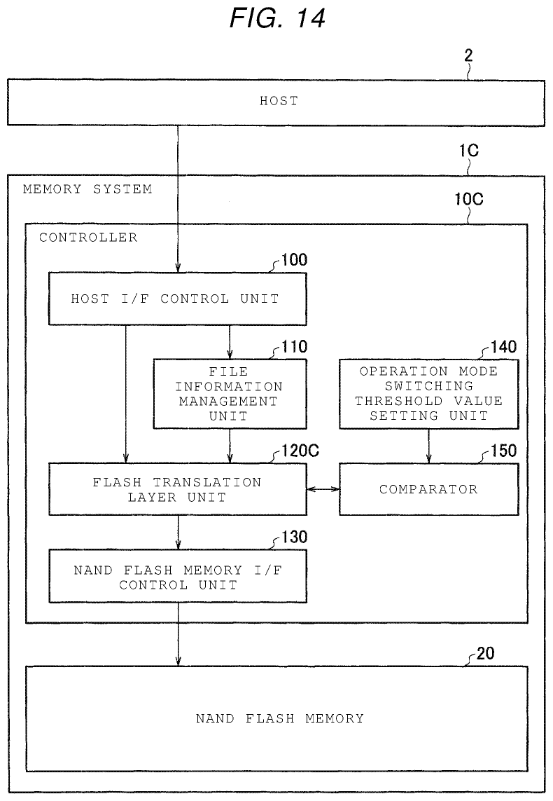

FIG. 14 is a block diagram illustrating the configuration of a memory system 1C according to the sixth embodiment.

The sixth embodiment further includes an operation mode switching threshold value setting unit 140 and a comparator 150 as compared to the memory system 1 according to the first embodiment.

A flash translation layer unit 120C according to the sixth embodiment outputs, for example, the information about the number of free remaining physical blocks of the NAND block to the comparator 150, in addition to providing the functions of the flash translation layer unit 120 according to the first embodiment.

The flash translation layer unit 120C has an added function of receiving an operation mode setting as determined by the comparator 150 and then switching the operation mode according to the operation mode setting.

The operation mode in which data is allocated in the NAND block of the NAND flash memory 20 of the memory system 1C according to the sixth embodiment is the same as that for the memory system 1 according to the first embodiment (which is referred to as operation mode A).

The operation mode switching threshold value setting unit 140 sets a predetermined threshold value for switching the operation mode according to when the remaining free NAND blocks of the NAND flash memory 20 are running low. In the following description, a predetermined threshold value for switching operation mode when the remaining free NAND blocks of the NAND flash memory 20 are running low is referred to as an operation mode switching threshold value.

The operation mode switching threshold value setting unit 140 outputs the threshold value to the comparator 150.

The comparator 150 switches the file allocation operation mode by which files are allocated in the NAND block of the NAND flash memory 20.

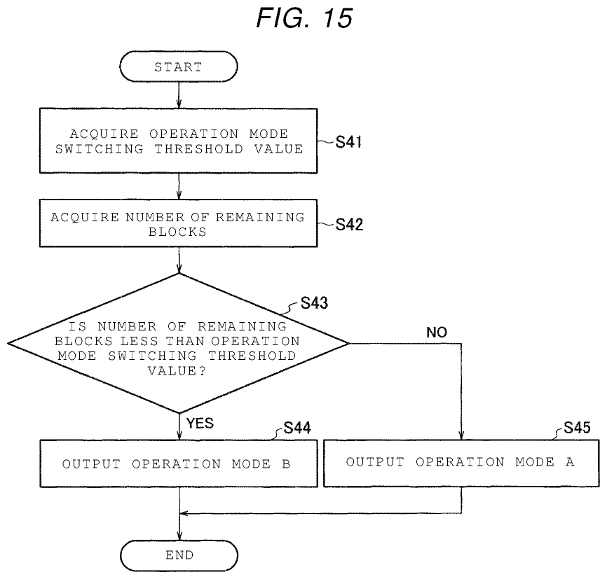

FIG. 15 is a flowchart illustrating an operation flow of the comparator 150 according to the sixth embodiment.

In step S41, the comparator 150 acquires the operation mode switching threshold value from the operation mode switching threshold value setting unit 140.

In step S42, the comparator 150 acquires the number of free remaining physical blocks for the NAND flash memory 20 from the flash translation layer unit 120C. In the following description, the number of free remaining physical blocks of the NAND flash memory 20 is referred to as the number of remaining blocks for simplicity.

If, in step S43, the number of remaining blocks is less than the operation mode switching threshold value, the process proceeds to step S44. When the number of remaining blocks is greater than the operation mode switching threshold value, the process proceeds to step S45.

In step S44, since the number of remaining blocks is less than the operation mode switching threshold value, the comparator 150 outputs an operation mode B signal (operation mode switching signal) to the flash translation layer unit 120C.

In step S45, since the number of remaining blocks is greater than the operation mode switching threshold value, the comparator 150 outputs the operation mode A signal to the flash translation layer unit 120C and file allocation operations remain as in one of the first to fifth embodiments.

Other configurations, operation flows, and effects of the memory system are the same as those of the first embodiment shown in FIGS. 1 to 7.

### Seventh Embodiment

In the seventh embodiment, the operation mode B is an operation mode in which data of the memory system 1C shown in FIG. 14 is allocated in the NAND blocks of the NAND flash memory 20 in a manner different from that of the operation mode A.

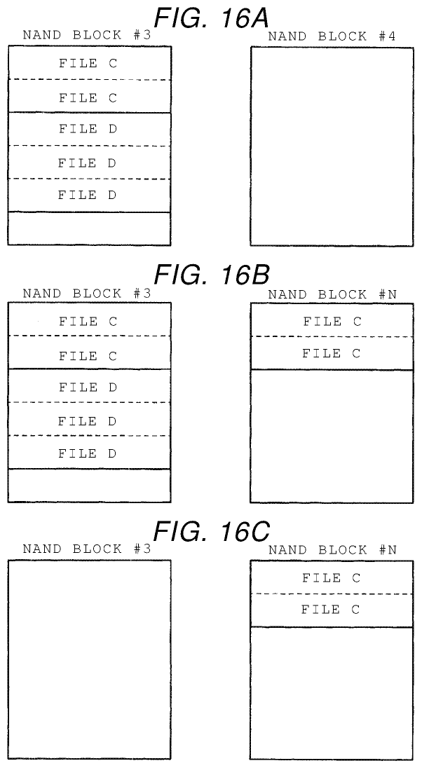

FIG. 16A is a diagram illustrating an operation mode B for writing to the NAND block according to the seventh embodiment. FIG. 16B is a diagram illustrating an example of copying a file of the NAND block shown in FIG. 16A to another NAND block. FIG. 16C is a diagram illustrating an example of erasing the NAND block after copying the file of the NAND block shown in FIG. 16B.

Specifically, first, in step S43 shown in FIG. 15, when it is determined that the number of remaining blocks is less than the operation mode switching threshold value, the process proceeds to step S44, and the operation mode B signal is output to the flash translation layer unit 120C.

In step S22 shown in FIG. 11 after the switch to operation mode B, when the LBA of the data write destination is translated into PBA, the flash translation layer unit 120C (shown in FIG. 14) allocates data having different file identifiers to the same NAND block.

That is, as shown in FIG. 16A, the flash translation layer unit 120C allocates the NAND block #3, which is a physical address of the NAND flash memory 20, to the file C and the file D such that multiple (at least two) files with different file identifiers are stored in one NAND block (NAND block #3, in this example).

The operation mode in which the flash translation layer unit 120C allocates different files to the same NAND block in NAND flash memory 20 in this way is referred to as the operation mode B.

For this operation mode B, the case where an UNMAP command is received from the host 2 for the file D (shown in FIG. 16A) will be described. Although the UNMAP command is taken as an example here, it may instead be a TRIM command or a delete command and the processing would be similarly performed. It is assumed here that a command from the host 2 causes a block of the NAND flash memory 20 including file D to be invalidated.

When the erasure level is set high by the UNMAP command from the host 2 or any instruction from the host 2, it will be determined that the erasure level for file D is high in step S24 (shown in FIG. 11), and a command to execute a NAND block erase will be output to the NAND flash memory I/F control unit 130 (in step S25).

As a result of this command to execute a NAND block erase, the file D in the NAND block #3 is invalidated, but the file C in the NAND block #3 is copied to the NAND block #N, as shown in FIG. 16B. Next, as shown in FIG. 16C, the NAND block #3 is erased entirely.

Other configurations, operating flows, and effects of the memory system are the same as in the sixth embodiment shown in FIG. 14.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A memory system, comprising:
a non-volatile semiconductor memory including a plurality of blocks; and
a controller configured to control the writing of data to the non-volatile semiconductor memory, the controller including:
a host I/F control interface configured to receive write command information including file allocation information indicating a location for write data,
a file information management unit configured to assign an erasure level to a file corresponding to the file allocation information and output a file identifier in which a file name, a file size, and the erasure level of the file are combined, and
a flash translation layer unit configured to allocate one file per block based on the write command information and the file identifier.

2. The memory system according to claim 1, wherein the file information management unit is further configured to:
extract a last update date and time for the file based on the received write command information,
calculate an elapsed time since the last update date and time of the file, and
assign the erasure level to the file based on the elapsed time.

3. The memory system according to claim 1, wherein the file information management unit is configured to:
extract a creation date and time for the file and a last open date for the file from the received write command information,
calculate a frequency of use for the file based on the creation date and time and the last open date, and
assign the erasure level to the file based on frequency of use.

4. The memory system according to claim 1, wherein, when executing a UNMAP command, a TRIM command, or garbage collection and invalidating a block, the flash translation layer unit executes a block erase on invalidated blocks storing a file having a high erasure level and deallocates invalidated blocks storing a file with a low erasure level.

5. The memory system according to claim 4, wherein the non-volatile semiconductor memory is NAND flash memory, the plurality of blocks are NAND blocks, and the block erase is a NAND block erase.

6. The memory system according to claim 1, wherein the host I/F control interface is configured to:
receive a deletable file candidate list from the file information management unit, the deletable file candidate list being a list of files with a high erasure level,
output the deletable file candidates list,
receive a file deletion request for a deletable file candidate on the deletable file candidate list, and
output the file deletion request to the file information management unit.

7. The memory system according to claim 6, wherein
the non-volatile semiconductor memory is NAND flash memory, and
the plurality of blocks are NAND blocks.

8. A memory system, comprising:
a non-volatile semiconductor memory including a plurality of blocks; and
a controller configured to control the writing of data to the non-volatile semiconductor memory, the controller including:
a host I/F control interface configured to receive write command information including file allocation indicating a location for write data,
a file information management unit configured to assign an erasure level to a file corresponding to the file allocation information and output a file identifier in which a file name, a file size, and the erasure level are combined,
a flash translation layer unit configured to allocate each file to a block based on the write command information and the file identifier,
an operation mode setting unit configured to set a threshold value for switching an operation mode of the flash translation layer unit, the threshold value corresponding to a number of available free blocks in the non-volatile semiconductor memory, and
a comparator configured to output an operation mode signal to the flash translation layer unit based on the threshold value set by the operation mode switching unit and the number of available free blocks from the flash translation layer unit, the operation mode signal indicating a first operation mode in which each file is allocated on a one file per block basis when the number of available free blocks is at or above the threshold value or a second operation mode in which different files can be allocated to the same block when the number of available free blocks is below the threshold value.

9. The memory system according to claim 8, wherein
the flash translation layer unit is configured to:
allocate a one file per block or a plurality of files per block based on the operation mode signal, and
select the erasure level and erasure method for files based on the operation mode signal.

10. The memory system according to claim 9, wherein the blocks are NAND blocks.

11. The memory system according to claim 8, wherein the blocks are NAND blocks.

12. The memory system according to claim 8, wherein the file information management unit is further configured to:
extract a last update date and time for the file based on the received write command information,
calculate an elapsed time since the last update date and time of the file, and
assign the erasure level to the file based on the elapsed time.

13. The memory system according to claim 8, wherein the file information management unit is configured to:
extract a creation date and time for the file and a last open date for the file from the received write command information,
calculate a frequency of use for the file based on the creation date and time and the last open date, and
assign the erasure level to the file based on frequency of use.

14. The memory system according to claim 8, wherein, when executing a UNMAP command, a TRIM command, or garbage collection and invalidating a block, the flash translation layer unit executes a block erase on invalidated blocks storing only a file having a high erasure level and deallocates invalidated blocks storing only files with a low erasure level.

15. The memory system according to claim 14, wherein
the non-volatile semiconductor memory is NAND flash memory,
the plurality of blocks are NAND blocks, and
the block erase is a NAND block erase.

16. The memory system according to claim 8, wherein the host I/F control interface is configured to:
receive a deletable file candidate list from the file information management unit, the deletable file candidate list being a list of files with a high erasure level,
output the deletable file candidates list,
receive a file deletion request for a deletable file candidate on the deletable file candidate list, and
output the file deletion request to the file information management unit.

17. A memory system, comprising:
a non-volatile semiconductor memory including a plurality of blocks; and
a controller configured to:
receive write command information including file allocation information indicating a location for write data,
assign an erasure level to a file corresponding to the file allocation information and output a file identifier in which a file name, a file size, and the erasure level of the file are combined, and
allocate one file per block based on the write command information and the file identifier.

18. The memory system according to claim 16, wherein, when executing a UNMAP command, a TRIM command, or garbage collection and invalidating a block, the controller is configured to execute a block erase on invalidated blocks storing a file having a high erasure level and deallocate invalidated blocks storing a file with a low erasure level.

19. The memory system according to claim 17, wherein the controller is further configured to:
extract a last update date and time for the file based on the received write command information,
calculate an elapsed time since the last update date and time of the file, and
assign the erasure level to the file based on the elapsed time.

20. The memory system according to claim 17, wherein the controller is further configured to:
extract a creation date and time for the file and a last open date for the file from the received write command information,
calculate a frequency of use for the file based on the creation date and time and the last open date, and
assign the erasure level to the file based on frequency of use.
